(19) United States
(12) Patent Application Publication
(10) Pub. No.: US 2019/0370702 A1
(43) Pub. Date: Dec. 5, 2019

(54) SYSTEMS AND METHODS FOR RECOMMENDING A PICK-UP LOCATION

(71) Applicant: BEIJING DIDI INFINITY TECHNOLOGY AND DEVELOPMENT CO., LTD., Beijing (CN)

(72) Inventor: Han LI, Beijing (CN)

(73) Assignee: BEIJING DIDI INFINITY TECHNOLOGY AND DEVELOPMENT CO., LTD., Beijing (CN)

(21) Appl. No.: 16/543,672

(22) Filed: Aug. 19, 2019

Related U.S. Application Data
(63) Continuation of application No. PCT/CN2018/077272, filed on Feb. 26, 2018.

(30) Foreign Application Priority Data
Mar. 2, 2017 (CN) 201710121186.X

(51) Int. Cl. G06Q 10/02; G06Q 50/30; G01C 21/34; H04W 4/02; H04W 4/40

(52) U.S. Cl. CPC G06Q 10/02; G06Q 50/30; H04W 4/40; H04W 4/025; G01C 21/3492

(57) ABSTRACT

A system and method for recommending a pick-up location are provided. The method may include: receiving a service request from a target user terminal; determining an area associated with a position of the target user terminal; determining at least one candidate location in the area; obtaining information related to a wireless network via which the target user terminal sends the service request; determining a likelihood score with respect to each of the at least one candidate location based on information associated with the target user terminal and the wireless network; determining a pick-up location from the at least one candidate location based on the likelihood scores associated with the at least one candidate location; and sending the pick-up location to the target user terminal in response to the service request.

### CROSS-REFERENCE TO RELATED APPLICATIONS

This application is a continuation of International Application No. PCT/CN2018/077272, filed on Feb. 26, 2018, which claims priority to Chinese Patent Application No. 201710121186.X filed on Mar. 2, 2017, the contents of which are incorporated herein by reference.

### TECHNICAL FIELD

The present disclosure generally relates to systems and methods for providing an on-demand service, and in particular, to systems and methods for recommending a pick-up location.

### BACKGROUND

On-demand transportation services, especially online car hailing services have become more and more popular. When a service requester (e.g., a passenger) requests a car via an online car hailing service platform using a user terminal, the server may recommend a pick-up location for both the service requester and a service provider (e.g., a driver) who provides transportation service for the service requester. The pick-up location is often determined based on Global Position System (GPS) information of the user terminal. A problem of determining the pick-up location based on GPS information is that the GPS information lacks of accuracy and stability. Accordingly, it is desirable to provide systems and methods for recommending pick-up locations more precisely and steadily.

### SUMMARY

According to an aspect of the present disclosure, a system may include at least one computer-readable storage medium including a set of instructions for recommending a pick-up location, and at least one processor in communication with the computer-readable storage medium, wherein when executing the set of instructions, the at least one processor may be directed to: receive a service request from a target user terminal; determine an area associated with a position of the target user terminal; determine at least one candidate location in the area; obtain information related to a wireless network via which the target user terminal sends the service request; determine a likelihood score with respect to each of the at least one candidate location based on information associated with the target user terminal and the wireless network; determine a pick-up location from the at least one candidate location based on the likelihood scores associated with the at least one candidate location; send the pick-up location to the target user terminal in response to the service request.

In some embodiments, to determine a likelihood score with respect to each of the at least one candidate location based on information associated with the target user terminal and the wireless network, the at least one processor is further directed to: obtain information related to a first set of historical services requested via the wireless network from the area; determine a first probability with respect to each of the at least one candidate location based on the information related to the first set of historical services, wherein the first probability corresponds to a first likelihood of the each of the at least one candidate location being assigned as a historical pick-up location in response to the first set of historical services requested via the wireless network in the area.

In some embodiments, to determine a likelihood score with respect to each of the at least one candidate location based on information associated with the target user terminal and the wireless network, the at least one processor is further directed to: obtain information related to a second set of historical services requested by the target user terminal via the wireless network; determine a second probability with respect to each of the at least one candidate location based on the information related to the second set of historical services, wherein the second probability corresponds to a second likelihood of the each of the at least one candidate location being assigned as a historical pick-up location in response to the second set of historical services requested by the target user terminal via the wireless network.

In some embodiments, to determine a likelihood score with respect to each of the at least one candidate location based on information associated with the target user terminal and the wireless network, the at least one processor is further directed to: determine a first weighted value associated with the first probability with respect to each of the at least one candidate location; determine a second weighted value associated with the second probability with respect to each of the at least one candidate location; determine the likelihood score with respect to each of the at least one candidate location based on the first probability, the second probability, the first weighted value, and the second weighted value.

In some embodiments, to determine at least one candidate location in the area, the at least one processor is further directed to: obtain a plurality of historical services associated with the area; determine a plurality of intersections based the plurality of historical services; determine a plurality of density values associated with the plurality of intersections, respectively; determine the at least one candidate location from the plurality of intersections based on the plurality of density values.

In some embodiments, to determine the plurality of intersections based the plurality of historical services, for each of the plurality of historical services, the at least one processor is further directed to: obtain a user terminal trace associated with the each of the plurality of historical services; obtain a driver terminal trace associated with the each of the plurality of historical services; determine an intersection based on the user terminal trace and the driver terminal trace.

In some embodiments, to determine the plurality of density values associated with the plurality of intersections, the at least one processor is further directed to: determine the plurality of density values according to a density peaks clustering algorithm.

In some embodiments, to determine a first probability with respect to each of the at least one candidate location based on the information related to the first set of historical services, the at least one processor is further directed to: determine a first count that each of the at least one candidate location was assigned as the historical pick-up location based on information related to the first set of historical services requested via the wireless network in the area; determine a second count that all of the at least one candidate location were assigned as the historical pick-up locations based on information related to the first set of historical services requested via the wireless network in the area; determine the first probability with respect to each of the at least one candidate location based on the first count and the second count.

In some embodiments, to determine a second probability with respect to each of the at least one candidate location based on the information related to the second set of historical services, the at least one processor is further directed to: determine a third count that each of the at least one candidate location was assigned as the historical pick-up location based on information related to the second set of historical services requested by the target user terminal via the wireless network; determine a fourth count that all of the at least one candidate location were assigned as the historical pick-up locations based on information related to the second set of historical services requested by the target user terminal via the wireless network; determine the second probability with respect to each of the at least one candidate location based on the third count and the fourth count.

According to another aspect of the present disclosure, a method for recommending a pick-up location may be implemented on a computing device having at least one processor, at least one computer-readable storage medium, and a communication platform connected to a network. The method may include one or more following operations: receiving a service request from a target user terminal; determining an area associated with a position of the target user terminal; determining at least one candidate location in the area; obtaining information related to a wireless network via which the target user terminal sends the service request; determining a likelihood score with respect to each of the at least one candidate location based on information associated with the target user terminal and the wireless network; determining a pick-up location from the at least one candidate location based on the likelihood scores associated with the at least one candidate location; sending the pick-up location to the target user terminal in response to the service request.

In some embodiments, the determining a likelihood score with respect to each of the at least one candidate location based on information associated with the target user terminal and the wireless network may include: obtaining information related to a first set of historical services requested via the wireless network from the area; determining a first probability with respect to each of the at least one candidate location based on the information related to the first set of historical services, wherein the first probability corresponds to a first likelihood of the each of the at least one candidate location being assigned as a historical pick-up location in response to the first set of historical services requested via the wireless network in the area.

In some embodiments, the determining a likelihood score with respect to each of the at least one candidate location based on information associated with the target user terminal and the wireless network may include: obtaining information related to a second set of historical services requested by the target user terminal via the wireless network; determining a second probability with respect to each of the at least one candidate location based on the information related to the second set of historical services, wherein the second probability corresponds to a second likelihood of the each of the at least one candidate location being assigned as a historical pick-up location in response to the second set of historical services requested by the target user terminal via the wireless network.

In some embodiments, the determining a likelihood score with respect to each of the at least one candidate location based on information associated with the target user terminal and the wireless network may include: determining a first weighted value associated with the first probability with respect to each of the at least one candidate location; determining a second weighted value associated with the second probability with respect to each of the at least one candidate location; determining the likelihood score with respect to each of the at least one candidate location based on the first probability, the second probability, the first weighted value, and the second weighted value.

In some embodiments, the determining at least one candidate location in the area may include: obtaining a plurality of historical services associated with the area; determining a plurality of intersections based the plurality of historical services; determining a plurality of density values associated with the plurality of intersections, respectively; determining the at least one candidate location from the plurality of intersections based on the plurality of density values.

In some embodiments, the determining the plurality of intersections based the plurality of historical services may include: for each of the plurality of historical services, obtaining a user terminal trace associated with the each of the plurality of historical services; obtaining a driver terminal trace associated with the each of the plurality of historical services; determining an intersection based on the user terminal trace and the driver terminal trace.

In some embodiments, the determining the plurality of density values associated with the plurality of intersections may include: determining the plurality of density values according to a density peaks clustering algorithm.

In some embodiments, the determining a first probability with respect to each of the at least one candidate location based on the information related to the first set of historical services may include: determining a first count that each of the at least one candidate location was assigned as the historical pick-up location based on information related to the first set of historical services requested via the wireless network in the area; determining a second count that all of the at least one candidate location were assigned as the historical pick-up locations based on information related to the first set of historical services requested via the wireless network in the area; determining the first probability with respect to each of the at least one candidate location based on the first count and the second count.

In some embodiments, the determine a second probability with respect to each of the at least one candidate location based on the information related to the second set of historical services may include: determining a third count that each of the at least one candidate location was assigned as the historical pick-up location based on information related to the second set of historical services requested by the target user terminal via the wireless network; determining a fourth count that all of the at least one candidate location were assigned as the historical pick-up locations based on information related to the second set of historical services requested by the target user terminal via the wireless network; determining the second probability with respect to each of the at least one candidate location based on the third count and the fourth count.

According to still another aspect of the present disclosure, a non-transitory computer readable medium, comprising at least one set of instructions for recommending a pick-up location, wherein when executed by at least one processor of a computer device, the at least one set of instructions directs the at least one processor to: receive a service request from a target user terminal; determine an area associated with a position of the target user terminal; determine at least one candidate location in the area; obtain information related to a wireless network via which the target user terminal sends the service request; determine a likelihood score with respect to each of the at least one candidate location based on information associated with the target user terminal and the wireless network; determine a pick-up location from the at least one candidate location based on the likelihood scores associated with the at least one candidate location; send the pick-up location to the target user terminal in response to the service request.

### BRIEF DESCRIPTION OF THE DRAWINGS

The present disclosure is further described in terms of exemplary embodiments. The foregoing and other aspects of embodiments of the present disclosure are made more evident in the following detail description, when read in conjunction with the attached drawing figures.

FIG. 1 is a block diagram of an exemplary system for recommending a pick-up location according to some embodiments of the present disclosure;

FIG. 2 is a schematic diagram illustrating exemplary hardware and/or software components of a computing device according to some embodiments of the present disclosure;

FIG. 3 is a schematic diagram illustrating exemplary hardware and/or software components of a mobile device according to some embodiments of the present disclosure;

FIG. 4 is a block diagram illustrating an exemplary processing engine according to some embodiments of the present disclosure;

FIG. 5 is a flowchart illustrating an exemplary process and/or method for determining a pick-up location according to some embodiments of the present disclose;

FIG. 6 is a flowchart illustrating an exemplary process and/or method for determining a first probability with respect to each of at least one candidate location according to some embodiments of the present disclose;

FIG. 7 is a flowchart illustrating an exemplary process and/or method for determining a second probability with respect to each of at least one candidate location according to some embodiments of the present disclose;

FIG. 8 is a flowchart illustrating an exemplary process and/or method for determining a likelihood score with respect to each of at least one candidate location according to some embodiments of the present disclose;

FIG. 9 is a flowchart illustrating an exemplary process and/or method for determining at least one candidate location in an area according to some embodiments of the present disclose;

FIG. 10 is a flowchart illustrating an exemplary process and/or method for determining an intersection according to some embodiments of the present disclose;

FIG. 11 is a flowchart illustrating an exemplary process and/or method for determining a first probability with respect to each of at least one candidate location according to some embodiments of the present disclose; and

FIG. 12 is a flowchart illustrating an exemplary process and/or method for determining a second probability with respect to each of at least one candidate location according to some embodiments of the present disclose.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprises,” “comprising,” “includes,” and/or “including” when used in this specification, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawing(s), all of which form a part of this specification. It is to be expressly understood, however, that the drawing(s) are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowcharts may be implemented not in order. Conversely, the operations may be implemented in inverted order or simultaneously. Moreover, one or more other operations may be added to the flowcharts. One or more operations may be removed from the flowcharts.

Moreover, while the system and method in the present disclosure is described primarily in regard to online car hailing services, it should also be understood that this is only one exemplary embodiment. The system or method of the present disclosure may be applied to any other kind of on-demand service. For example, the system or method of the present disclosure may be applied to different transportation systems including land, ocean, aerospace, or the like, or any combination thereof. The vehicle of the transportation systems may include a taxi, a private car, a hitch, a bus, a train, a bullet train, a high speed rail, a subway, a vessel, an aircraft, a spaceship, a hot-air balloon, a driverless vehicle, or the like, or any combination thereof. The transportation system may also include any transportation system that applies management and/or distribution, for example, a system for sending and/or receiving an express. The application scenarios of the system or method of the present disclosure may include a webpage, a plug-in of a browser, a client terminal, a custom system, an internal analysis system, an artificial intelligence robot, or the like, or any combination thereof.

The term “pick-up location” in the present disclosure may refer to a location that a service provider starts providing a service initiated by a service requester. For example, in an online car hailing service, a service provider may pick up a service requester who initiated the service at a crossroad and drive the service requester to the service requester's destination. The crossroad may be the pick-up location of the service. The term “candidate location” in the present disclosure may refer to a location including a potential location at which a service provider starts providing a service initiated by a target user terminal in the area and/or a historical pick-up location in the area.

The position and/or trace in the present disclosure may be acquired by positioning technology embedded in a user terminal. The positioning technology used in the present disclosure may include a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning technologies may be used interchangeably in the present disclosure.

An aspect of the present disclosure relates to online systems and methods for recommending a pick-up location. According to the present disclosure, the systems and methods may determine at least one historical pick-up location in an area after receiving a service request from a target user terminal. The systems and methods may calculate a probability with respect to each of the at least one historical pick-up location based on historical information related to a wireless network via which the user terminals in an area send the service request and historical information related to the target user terminal in the area that requested the services. The systems and methods may recommend a pick-up location from the at least one historical pick-up location in the area based on the probability. If one of the historical pick-up locations has a highest probability, the systems and methods may recommend the historical pick-up location to the target user terminal.

It should be noted that the online on-demand service is a newly emerged service rooted in post-Internet era. It provides the technical solutions to service requesters that could rise in post-Internet era. In pre-Internet era, it is impossible to determine a pick-up location based on a wireless network via which a target user terminal sends a service request. Therefore, the present solution is deeply rooted in and aimed to solve a problem only occurred in post-Internet era.

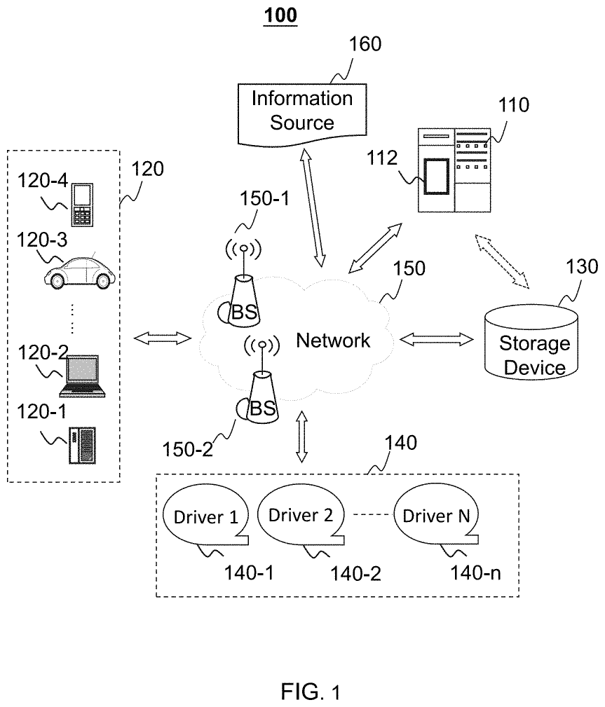

FIG. 1 is a block diagram of an exemplary system 100 for recommending a pick-up location according to some embodiments of the present disclosure. For example, the system 100 may be an online transportation service platform for transportation services such as car hailing services, chauffeur services, vehicle delivery services, carpooling services, bus services, driver hiring services, and shuttle services, etc. The system 100 may include a server 110, a user terminal 120, a storage device 130, a driver terminal 140, a network 150 and an information source 160. The server 110 may include a processing engine 112.

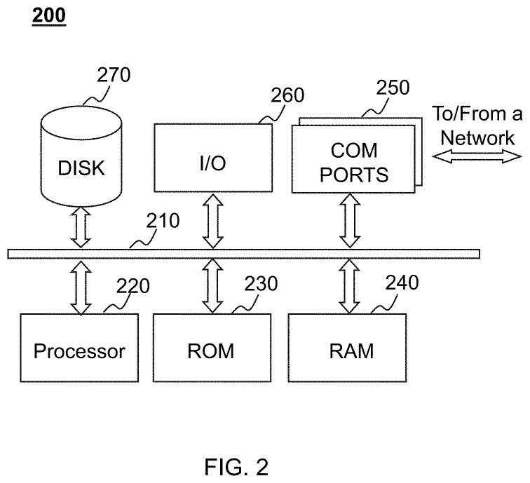

The server 110 may be configured to process information and/or data relating to a service request, for example, a service request for hailing a car. For example, the server 110 may receive a service request from a user terminal 120, and process the service request to recommend a pick-up location to the user terminal 120. In some embodiments, the server 110 may be a single server, or a server group. The server group may be centralized, or distributed (e.g., the server 110 may be a distributed system). In some embodiments, the server 110 may be local or remote. For example, the server 110 may access information and/or data stored in the user terminal 120, the driver terminal 140 and/or the storage device 130 via the network 150. As another example, the server 110 may be directly connected to the user terminal 120, the driver terminal 140 and/or the storage device 130 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device having one or more components illustrated in FIG. 2 in the present disclosure.

In some embodiments, the server 110 may include a processing engine 112. The processing engine 112 may process information and/or data relating to the service request to perform one or more functions described in the present disclosure. For example, the processing engine 112 may obtain a service request from the user terminal 120 to hail a car. In some embodiments, the processing engine 112 may include one or more processing engines (e.g., single-core processing engine(s) or multi-core processor(s)). Merely by way of example, the processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

In some embodiments, the user terminal 120 and/or the driver terminal 140 may be an individual, a tool or other entity directly relating to the request. A user may be a service requester. In the present disclosure, “user,” “user terminal” may be used interchangeably. A driver may be a service provider. In the present disclosure, “driver,” “driver terminal” may be used interchangeably. In some embodiments, the user terminal 120 may include a mobile device 120-1, a tablet computer 120-2, a laptop computer 120-3, and a built-in device 120-4 in a motor vehicle, or the like, or any combination thereof. In some embodiments, the mobile device 120-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, a smart glass, a smart helmet, a smart watch, a smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass, an Oculus Rift, a HoloLens, a Gear VR, etc. In some embodiments, built-in device in the motor vehicle 120-4 may include an onboard computer, an onboard television, etc. In some embodiments, the user terminal 120 may be a device with positioning technology for locating the position of the user and/or the user terminal 120.

In some embodiments, the driver terminal 140 may be similar to, or the same device as the user terminal 120. In some embodiments, the driver terminal 140 may be a device with positioning technology for locating the position of the driver and/or the driver terminal 140. In some embodiments, the user terminal 120 and/or the driver terminal 140 may communicate with another positioning device to determine the position of the user, the user terminal 120, the driver, and/or the driver terminal 140. In some embodiments, the user terminal 120 and/or the driver terminal 140 may transmit positioning information to the server 110.

The storage device 130 may store data and/or instructions related to the service request. In some embodiments, the storage device 130 may store data obtained/acquired from the user terminal 120 and/or the driver terminal 140. In some embodiments, the storage device 130 may store data and/or instructions that the server 110 may execute or use to perform exemplary methods described in the present disclosure. In some embodiments, the storage device 140 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (PEROM), an electrically erasable programmable ROM (EEPROM), a compact disk ROM (CD-ROM), and a digital versatile disk ROM, etc. In some embodiments, the storage device 130 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 130 may be connected to the network 150 to communicate with one or more components in the system 100 (e.g., the server 110, the user terminal 120, the driver terminal 140). One or more components in the system 100 may access the data or instructions stored in the storage device 130 via the network 150. In some embodiments, the storage device 130 may be directly connected to or communicate with one or more components in the system 100 (e.g., the server 110, the terminal 130, the driver terminal 140, etc.). In some embodiments, the storage device 130 may be part of the server 110.

The network 150 may facilitate exchange of information and/or data. In some embodiments, one or more components in the system 100 (e.g., the server 110, the user terminal 120, the storage device 130, and the driver terminal 140) may send and/or receive information and/or data to/from other component(s) in the system 100 via the network 150. For example, the server 110 may obtain/acquire service request from the user terminal 120 and/or the driver terminal 140 via the network 150. In some embodiments, the network 150 may be any type of wired or wireless network, or combination thereof. Merely by way of example, the network 150 may include a cable network, a wireline network, an optical fiber network, a tele communications network, an intranet, an Internet, a local area network (LAN), a wide area network (WAN), a wireless local area network (WLAN), a metropolitan area network (MAN), a wide area network (WAN), a public telephone switched network (PSTN), a Bluetooth™ network, a ZigBee™ network, a near field communication (NFC) network, a global system for mobile communications (GSM) network, a code-division multiple access (CDMA) network, a time-division multiple access (TDMA) network, a general packet radio service (GPRS) network, an enhanced data rate for GSM evolution (EDGE) network, a wideband code division multiple access (WCDMA) network, a high speed downlink packet access (HSDPA) network, a long term evolution (LTE) network, a user datagram protocol (UDP) network, a transmission control protocol/Internet protocol (TCP/IP) network, a short message service (SMS) network, a wireless application protocol (WAP) network, a ultra wide band (UWB) network, an infrared ray, or the like, or any combination thereof. In some embodiments, the system 100 may include one or more network access points. For example, the system 110 may include wired or wireless network access points such as base stations and/or wireless access points 150-1, 150-2, . . . , through which one or more components of the system 100 may be connected to the network 150 to exchange data and/or information.

The information source 160 may be a source configured to provide other information for the system 100. The information source 160 may provide the system 100 with service information, such as weather conditions, traffic information, information of laws and regulations, news events, life information, life guide information, or the like. The information source 160 may be implemented in a single central server, multiple servers connected via a communication link, or multiple personal devices. When the information source 160 is implemented in multiple personal devices, the personal devices can generate content (e.g., as referred to as the “user-generated content”), for example, by uploading text, voice, image, and video to a cloud server. An information source may be generated by the multiple personal devices and the cloud server.

FIG. 2 is a schematic diagram illustrating exemplary hardware and software components of a computing device 200 on which the server 110, the user terminal 120, the storage device 130, the driver 140 and/or the information source 160 may be implemented according to some embodiments of the present disclosure. The particular system may use a functional block diagram to explain the hardware platform containing one or more user interfaces. The computer may be a computer with general or specific functions. Both types of the computers may be configured to implement any particular system according to some embodiments of the present disclosure. Computing device 200 may be configured to implement any components that perform one or more functions disclosed in the present disclosure. For example, the computing device 200 may implement any component of the system 100 as described herein. In FIGS. 1-2, only one such computer device is shown purely for convenience purposes. One of ordinary skill in the art would understand at the time of filing of this application that the computer functions relating to the on-demand service as described herein may be implemented in a distributed fashion on a number of similar platforms, to distribute the processing load.

The computing device 200, for example, may include COM ports 250 connected to and from a network connected thereto to facilitate data communications. The computing device 200 may also include a processor (e.g., the processor 220), in the form of one or more processors (e.g., logic circuits), for executing program instructions. For example, the processor may include interface circuits and processing circuits therein. The interface circuits may be configured to receive electronic signals from a bus 210, wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the bus 210.

The exemplary computing device may include the internal communication bus 210, program storage and data storage of different forms including, for example, a disk 270, and a read only memory (ROM) 230, or a random access memory (RAM) 240, for various data files to be processed and/or transmitted by the computing device. The exemplary computing device may also include program instructions stored in the ROM 230, RAM 240, and/or other type of non-transitory storage medium to be executed by the processor 220. The methods and/or processes of the present disclosure may be implemented as the program instructions. The computing device 200 also includes an I/O component 260, supporting input/output between the computer and other components. The computing device 200 may also receive programming and data via network communications.

Merely for illustration, only one CPU and/or processor is illustrated in FIG. 2. Multiple CPUs and/or processors are also contemplated; thus operations and/or method steps performed by one CPU and/or processor as described in the present disclosure may also be jointly or separately performed by the multiple CPUs and/or processors. For example, if in the present disclosure the CPU and/or processor of the computing device 200 executes both step A and step B, it should be understood that step A and step B may also be performed by two different CPUs and/or processors jointly or separately in the computing device 200 (e.g., the first processor executes step A and the second processor executes step B, or the first and second processors jointly execute steps A and B).

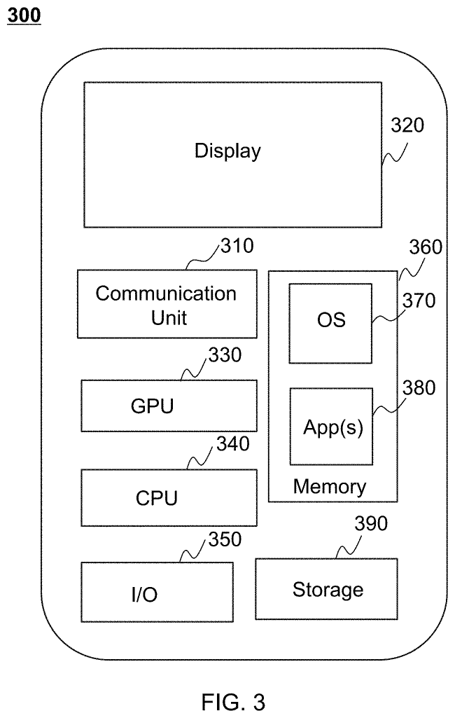

FIG. 3 is a schematic diagram illustrating exemplary hardware and/or software components of an exemplary mobile device 300 on which the requester terminal 130 or the provider terminal 140 may be implemented according to some embodiments of the present disclosure. As illustrated in FIG. 3, the mobile device 300 may include a communication platform 310, a display 320, a graphic processing unit (GPU) 330, a central processing unit (CPU) 340, an I/O 350, a memory 360, and a storage 390. The CPU 340 may include interface circuits and processing circuits similar to the processor 220. In some embodiments, any other suitable component, including but not limited to a system bus or a controller (not shown), may also be included in the mobile device 300. In some embodiments, a mobile operating system 370 (e.g., iOS™, Android™, Windows Phone™, etc.) and one or more applications 380 may be loaded into the memory 360 from the storage 390 in order to be executed by the CPU 340. The applications 380 may include a browser or any other suitable mobile apps for receiving and rendering information relating to a service request or other information from the location based service providing system on the mobile device 300. User interactions with the information stream may be achieved via the I/O devices 350 and provided to the processing engine 112 and/or other components of the system 100 via the network 120.

In order to implement various modules, units and their functions described above, a computer hardware platform may be used as hardware platforms of one or more elements (e.g., a module of the sever 110 described in FIG. 2). Since these hardware elements, operating systems, and program languages are common, it may be assumed that persons skilled in the art may be familiar with these techniques and they may be able to provide information required in the route planning according to the techniques described in the present disclosure. A computer with user interface may be used as a personal computer (PC), or other types of workstations or terminal devices. After being properly programmed, a computer with user interface may be used as a server. It may be considered that those skilled in the art may also be familiar with such structures, programs, or general operations of this type of computer device. Thus, extra explanations are not described for the figures.

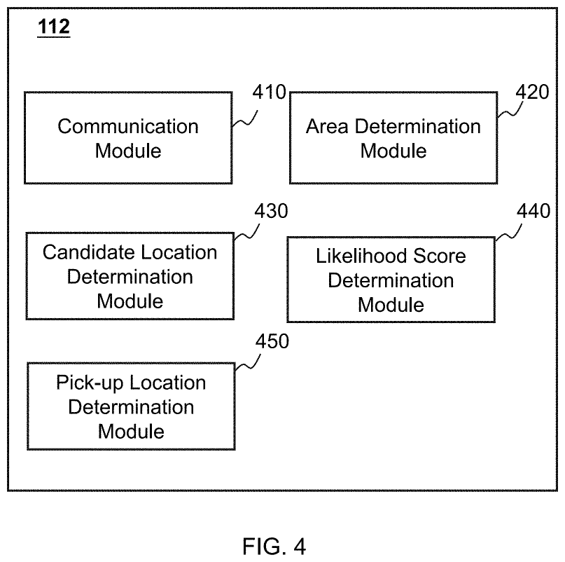

FIG. 4 is a block diagram illustrating an exemplary processing engine 112 according to some embodiments. The processing engine 112 may include a communication module 410, an area determination module 420, a candidate location determination module 430, a likelihood score determination module 440 and a pick-up location determination module 450. The modules may be hardware circuits of all or part of the processing engine 112. The modules may also be implemented as an application or set of instructions read and executed by the processing engine. Further, the modules may be any combination of the hardware circuits and the application/instructions. For example, the modules may be the part of the processing engine 112 when the processing engine is executing the application/set of instructions.

The communication module 410 may be configured to receive and/or send information related to the service request from and/or to one or more components in the system 100 (e.g., the user terminal 120, the driver terminal 140, the storage device 130, etc.). For example, the communication module 410 may receive a service request from a target user terminal, obtain information related to a wireless network via which the target user terminal sends the service request, obtain information related to a first set of historical services, obtain information related to a second set of historical services, send the pick-up location to the target terminal in response to the service request, or the like, or any combination thereof.

The area determination module 420 may be configured to determine an area associated with a position of the target user terminal. For example, the area determination module 420 may determine the area based on the positioning information of the target user terminal. As another example, the area determination module 420 may determine the size and/or the shape of the area.

The candidate location determination module 430 may be configured to determine at least one candidate location in the area. For example, the candidate location determination module 430 may determine a plurality of intersections based on a plurality of historical services, determine a plurality of density values associated with the plurality of intersections, respectively, and determine the at least one candidate location based on the plurality of density values.

In some embodiments, the likelihood score determination module 440 may be configured to determine a likelihood score with respect to each of the at least one candidate location. For example, the likelihood score determination module 440 may determine a first probability and a second probability for each of the at least one candidate location and determine the likelihood score with respect to each of the at least one candidate location based on the first probability and the second probability.

In some embodiments, the pick-up location determination module 450 may be configured to determine a pick-up location in response to the service request. For example, the pick-up location determination module 450 may determine the pick-up location from the at least one candidate location based on the likelihood scores associated with the at least one candidate location.

The modules in the processing engine 112 may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth™, a ZigBee™, a Near Field Communication (NFC), or the like, or any combination thereof. Two or more of the modules may be combined as a single module, and any one of the modules may be divided into two or more units. For example, the candidate location determination module 430 may be integrated in the likelihood score determination module 440 as a single module that may both determine at least one candidate location in the area and determine a likelihood score for each of the at least one candidate location. As another example, the likelihood score determination module 440 may be divided into three units of a first probability determination unit, a second probability determination unit and a likelihood score determination unit to implement the functions of the likelihood score determination module 440, respectively.

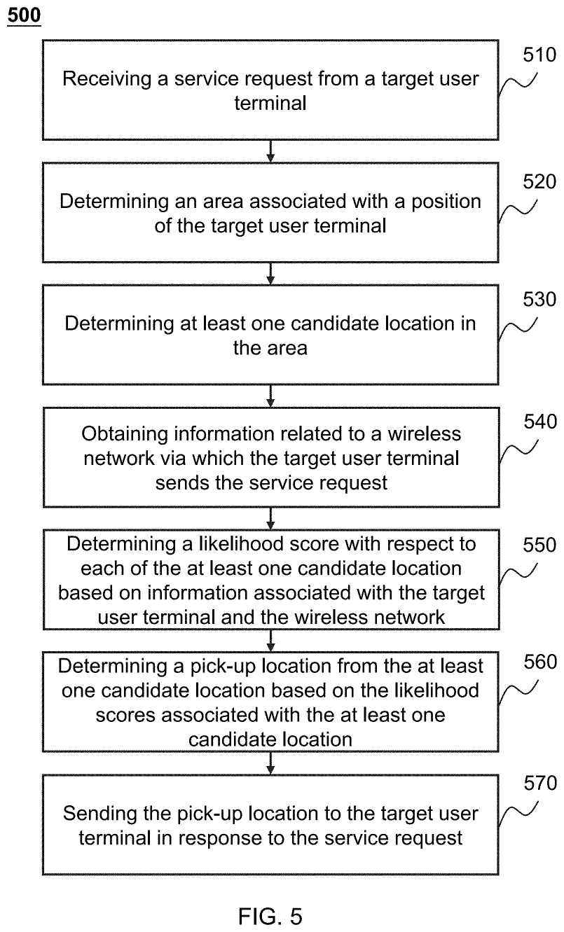

FIG. 5 is a flowchart of an exemplary process and/or method 500 for determining a pick-up location according to some embodiments of the present disclose. In some embodiments, one or more steps in the process 500 may be implemented in the system 100 illustrated in FIG. 1. For example, one or more steps in the process 500 may be stored in the storage device 130 and/or the storage (e.g., the ROM 230, the RAM 240, etc.) as a form of instructions, and invoked and/or executed by the server 110 (e.g., the processing engine 112 in the server 110, or the processor 220 of the processing engine 112 in the server 110).

In 510, the processor 220 (or the communication module 410) may receive a service request from a target user terminal.

In some embodiments, the processor 220 (or the communication module 410) may be an online on-demand service platform (e.g., a transportation service platform), such as the system 100. In some embodiments, the service request may be related to a transportation service request, for example, an online car hailing service request, a taxi service request, a tailored car service request, or the like, or any combination thereof.

The target user terminal may include a terminal (e.g., a wireless device such as a smart phone) used by a user (e.g., a passenger, a service requester) to initiate the service request. For example, the target user terminal may be implemented with an application through which the service request is initiated.

In some embodiments, the service request may include a user identifier of the target user terminal, a request time, a start location of the service, a destination of the service, a position of the target user terminal where the target user terminal initiates the service request, whether the target user terminal accepts dynamic price adjustment (e.g., raising the service price), whether the target user terminal accepts to change a service mode (e.g., from taxi service to carpooling service), or the like, or any combination thereof.

In 520, the processor 220 (or the area determination module 420) may determine an area associated with a position of the target user terminal.

In some embodiments, the position may include a position where the target user terminal initiates the service request. The target user terminal may be implemented with an application that can obtain the location of the target user terminal via communicating with a positioning system. The target user terminal may send the position to the processor 220 via the network 150. The positioning technology may include a Global Positioning System (GPS) technology, a Beidou navigation system technology, a Global Navigation Satellite System (GLONASS) technology, a Galileo positioning system (Galileo) technology, a Quasi-Zenith Satellite System (QAZZ) technology, a base station positioning technology, a Wi-Fi positioning technology, or the like, or any combination thereof.

In some embodiments, the processor 220 (or the area determination module 420) may determine the area associated with the position obtained from the target user terminal. The area may be a geographic area that includes the position of the target user terminal. For example, the processor 220 may divide a map of a region (e.g., an urban map) that the position belongs to into a plurality of grids. The area may include one or more grids of the plurality of the grids on or around the position of the target user terminal. The plurality of the grids may or may not have a same geographic size. For example, the processor 220 (or the area determination module 420) may determine the same size of each grid. As another example, the processor 220 (or the area determination module 420) may determine different sizes of each grid according to different situations (e.g., different request time, different urbans, different service mode, etc.). In some embodiments, the shape of each grid may include a square, a rectangle, a circular, a triangle, a trapezoid, a rhombic, an irregular shape, or the like, or any combination thereof. Merely by way of example, the processor 220 (or the area determination module 420) may determine a square area as the area associated with the position, in which the position of the target user terminal is the center of the square area, and the side length of the area is 2 kilometers. As another example, the processor 220 (or the area determination module 420) may determine a building close to the position as the area associated with the position. It should be noted that the size and the shape of the girds may be adjusted according to the different situations of the system and similar modifications are within the scope of the discourse.

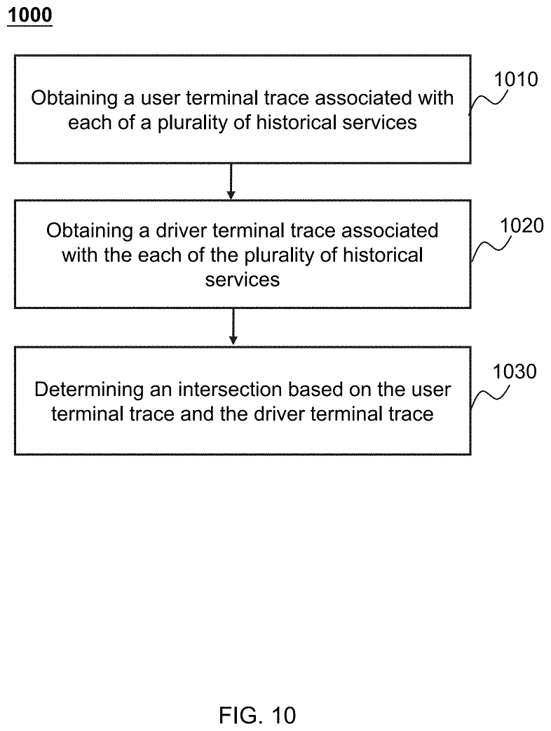

In 530, the processor 220 (or the candidate location determination module 430) may determine at least one candidate location in the area. In some embodiments, the at least one candidate location may include a potential location at which a service provider starts providing a service initiated by a target user terminal in the area. For example, in an online car hailing service, the at least one candidate location may include a location where the service provider (such as a driver) picks up the service requester (such as a passenger), or a location where the driver begins to charge for the service being provided to the passenger. In some embodiments, the at least one candidate location may include a historical service location in the area. For example, in a historical online taxi service, the at least one candidate location may include a historical location where a driver picked up a passenger in the area with respect to the historical online taxi service. In some embodiments, the at least one candidate location may include a crossroad, a bus station, a gate of a building, a gate of a community, a gate of a park, or the like, or any combination thereof. For example, the determined area is an office building, the at least one candidate location in the determined area may include four gates of the office building. The determination of the at least one candidate location in the area may be found in FIG. 10 and the description thereof in the present disclosure.

In 540, the processor 220 (or the communication module 410) may obtain information related to a wireless network via which the target user terminal sends the service request. In some embodiments, the target user terminal may have a wireless access capability to access the wireless network. The wireless network may include a wireless-fidelity (Wi-Fi) network, a fifth-generation mobile communication (5G) network, a fourth-generation mobile communication (4G) network, a third-generation mobile communication (3G) network, a second-generation mobile communication (2G) network, a blue tooth network, a ZigBee network, or the like, or any combination thereof. The target user terminal may connect to the wireless network and send the service request via the wireless network to the server 110 via the network 150. For example, the target user terminal may connect to a Wi-Fi network in the area, and send the service request via the Wi-Fi network. The processor 220 (or the communication module 410) may obtain the Wi-Fi network. As another example, the target user terminal may connect to a 4G network from a base station in the area, and send the service request via the 4G network. The processor 220 (or the communication module 410) may obtain information related to the 4G network and the base station.

In 550, the processor 220 (or the likelihood score determination module 440) may determine a likelihood score with respect to each of the at least one candidate location based on information associated with the target user terminal and the wireless network.

In some embodiments, the likelihood score may include a probability that the target user terminal may use each of the candidate locations as the pick-up location in the area. For example, the area includes a candidate location A and a candidate location B. In an online car hailing service, the likelihood score of the candidate location A is 0.7 and the likelihood score of the candidate location B is 0.3, which means that the probability that the target user terminal may use the candidate location A is 70 percent and the potential probability that the target user terminal may use the candidate location B is 30 percent.

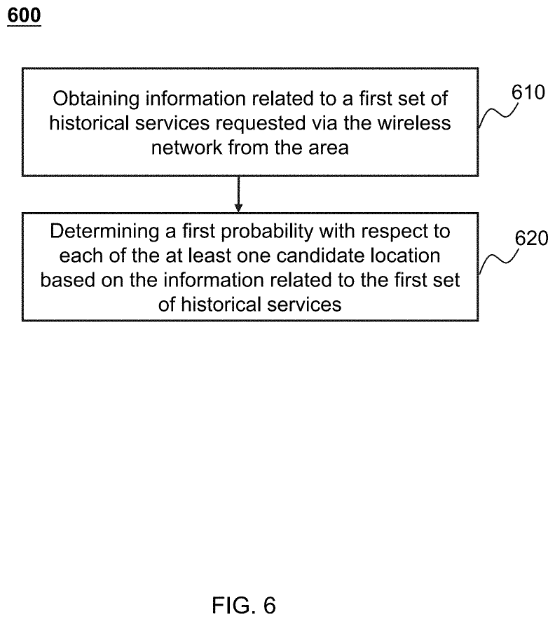

In some embodiments, the processor 220 (or the likelihood score determination module 440) may determine the likelihood score based on information associated with the target user terminal and the wireless network. In some embodiments, the information associated with the target user terminal and the wireless network may include information related to a first set of historical services requested via the wireless network from the area, information related to a second set of historical services requested by the target user terminal via the wireless network, or the like, or any combination thereof. For example, the processor 220 (or the likelihood score determination module 440) may determine the likelihood score based on a first probability with respect to each of the at least one candidate location based on the information related to the first set of historical services, and a second probability with respect to each of the at least one candidate location based on the information related to the second set of historical services. The first probability may be a first likelihood of the each of the at least one candidate location being used as a historical pick-up location in response to the first set of historical services requested via the wireless network in the area. The second probability may be a second likelihood of the each of the at least one candidate location being used as a historical pick-up location in response to the second set of historical services requested by the target user terminal via the wireless network. As another example, the processor 220 (or the likelihood score determination module 440) may determine the likelihood score based on a first weighted value associated with the first probability, the first probability, a second weighted value associated with the second probability, and the second probability. In some embodiments, the processor 220 (or the likelihood score determination module 440) may determine the priority of the first probability and the second probability and assign different weights to the first probability and the second probability accordingly. For example, if the second probability has a higher priority than the first probability, the second weighted value associated with the second probability may be greater than the first weighted value associated with the first probability. The determination of the likelihood score with respect to each of the at least one candidate location may be found in FIGS. 6-8 and the description thereof in the present disclosure.

In 560, the processor 220 (or the pick-up location determination module 450) may determine a pick-up location from the at least one candidate location based on the likelihood scores associated with the at least one candidate location.

In some embodiments, the pick-up location may be recommended to the target user terminal in response to the service request sent by the target user terminal via the wireless network in the area. For example, the processor 220 (or the pick-up location determination module 450) may select the pick-up location from the at least one candidate location based on the likelihood scores associated with the at least one candidate location. In some embodiments, the processor 220 (or the pick-up location determination module 450) may determine a pick-up location with a highest likelihood score among the at least one candidate location.

In 570, the processor 220 (or the communication module 410) may send the pick-up location to the target user terminal in response to the service request.

In some embodiments, the processor 220 (or the communication module 410) may send the pick-up location to the target user terminal via the network 150. In some embodiments, the processor 220 (or the communication module 410) may further send the pick-up location to a driver who accepts the service request. Once the pick-up location is confirmed by the user, the user of the target user terminal and the driver who accepts the service request may meet at the pick-up location to start the service.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step, a preprocessing step) may be added elsewhere in the exemplary process/method 500. As another example, all the steps in the exemplary process/method 500 may be implemented in a computer-readable medium including a set of instructions. The instructions may be transmitted in a form of electronic current or electrical signals.

FIG. 6 is a flowchart of an exemplary process and/or method 600 for determining a first probability with respect to each of at least one candidate location according to some embodiments of the present disclose. In some embodiments, one or more steps in the process 600 may be implemented in the system 100 illustrated in FIG. 1. For example, one or more steps in the process 600 may be stored in the storage device 130 and/or the storage (e.g., the ROM 230, the RAM 240, etc.) as a form of instructions, and invoked and/or executed by the server 110 (e.g., the processing engine 112 in the server 110, or the processor 220 of the processing engine 112 in the server 110).

In 610, the processor 220 (or the communication module 410) may obtain information related to a first set of historical services requested via the wireless network from the area.

In some embodiments, the first set of historical services may include a plurality of historical services requested by a plurality of user terminals via the wireless network in the area during a time period. For example, the processor 220 may obtain the first set of historical services during a preset time period, such as a week, a month, a quarter, a year, or the like. In some embodiments, the first set of historical services may include a preset number of historical services requested by a plurality of user terminals via the wireless network in the area. The preset number may be determined based on the area. For example, in a downtown area, the processor 220 may obtain 1000 recent historical services requested by a plurality of user terminals via the wireless network in the area as the first set of historical services.

In some embodiments, the information related to the first set of historical services may include historical request time, historical service time, a plurality of historical service locations, a plurality of historical service fees, or the like, or any combination thereof. For example, if the historical services are historical online car hailing services, the information related to the first set of historical services may include historical request time, a plurality of historical pick-up locations, a plurality of historical destinations, a plurality of service durations, a plurality of historical driving routes, or the like, or any combination thereof. In some embodiments, the processor 220 may obtain the information related to the first set of historical services by accessing data stored in the storage device 130, the ROM 230, the RAM 240 and/or the disk 270.

In 620, the processor 220 (or the likelihood score determination module 440) may determine a first probability with respect to each of the at least one candidate location based on the information related to the first set of historical services. In some embodiments, the first probability may correspond to a first likelihood of the each of the at least one candidate location being assigned as a historical pick-up location in response to the first set of historical services requested via the wireless network in the area. Each of the at least candidate location may be associated with a first probability.

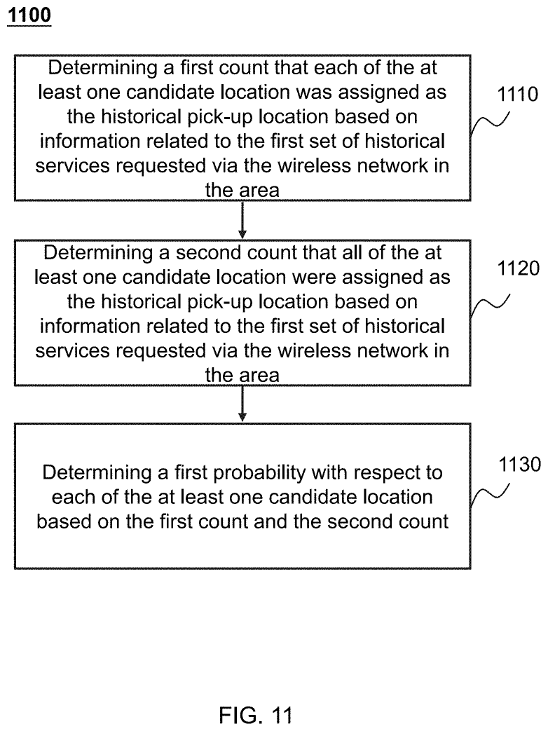

In some embodiments, the processor 220 (or the likelihood score determination module 440) may determine the first probability based on a first count that each of the at least one candidate location was assigned as the historical pick-up location and a second count that all of the at least one candidate location were assigned as the historical pick-up locations. The processor 220 may determine the first count and/or the second count based on information related to the first set of historical services. For example, the first probability with respect to each of the at least one candidate location may be a ratio of the first count to the second count. In some embodiments, the first count may be a total number of times that each of the at least one candidate location was used as a historical pick-up location in the first set of historical services requested via the wireless network in the area. The second count may be a total number of times that all of the at least one candidate location were used as the historical pick-up locations in the first set of historical services requested via the wireless network in the area. The determination of the first probability may be found in FIG. 11 and the description thereof in the present disclosure.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step, a preprocessing step) may be added elsewhere in the exemplary process/method 600. As another example, all the steps in the exemplary process/method 600 may be implemented in a computer-readable medium including a set of instructions. The instructions may be transmitted in a form of electronic current or electrical signals.

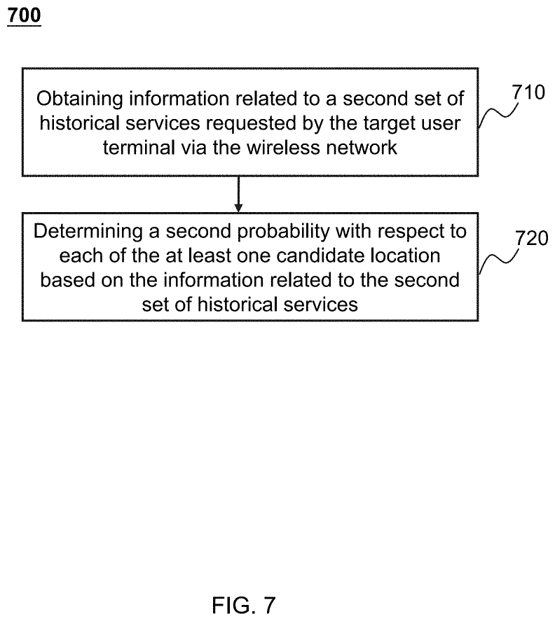

FIG. 7 is a flowchart of an exemplary process and/or method 700 for determining a second probability with respect to each of at least one candidate location according to some embodiments of the present disclose. In some embodiments, one or more steps in the process 700 may be implemented in the system 100 illustrated in FIG. 1. For example, one or more steps in the process 700 may be stored in the storage device 130 and/or the storage (e.g., the ROM 230, the RAM 240, etc.) as a form of instructions, and invoked and/or executed by the server 110 (e.g., the processing engine 112 in the server 110, or the processor 220 of the processing engine 112 in the server 110).

In 710, the processor 220 (or the communication module 410) may obtain information related to a second set of historical services requested by the target user terminal via the wireless network from the area.

In some embodiments, the second set of historical services may include a plurality of historical services requested by the target user terminals via the wireless network in the area during a time period. For example, the processor 220 may obtain the second set of historical services during a preset time period, such as a week, a month, a quarter, a year, or the like. In some embodiments, the second set of historical services may include a preset number of historical services requested by the target user terminal via the wireless network in the area. The preset number may be determined based on the area, and/or the target user terminal. For example, the processor 220 may obtain all historical services requested by the target user terminal via the wireless network in the area as the second set of historical services.

In some embodiments, the information related to the second set of historical services may include historical request time, historical service time, a plurality of historical service locations, a plurality of historical service fees, or the like, or any combination thereof. For example, if the historical services are historical online car hailing services, the information related to the second set of historical services may include historical request time, historical pick-up locations, a plurality of historical destinations, a plurality of service durations, a plurality of historical driving routes, or the like, or any combination thereof. In some embodiments, the processor 220 may obtain the information related to the second set of historical services by accessing data stored in the storage device 130, the ROM 230, the RAM 240 and/or the disk 270.

In 720, the processor 220 (or the likelihood score determination module 440) may determine a second probability with respect to each of the at least one candidate location based on the information related to the second set of historical services. In some embodiments, the second probability may correspond to a second likelihood of the each of the at least one candidate location being assigned as a historical pick-up location in response to the second set of historical services requested by the target user terminal via the wireless network in the area. Each of the at least one candidate location may be associated with a second probability.

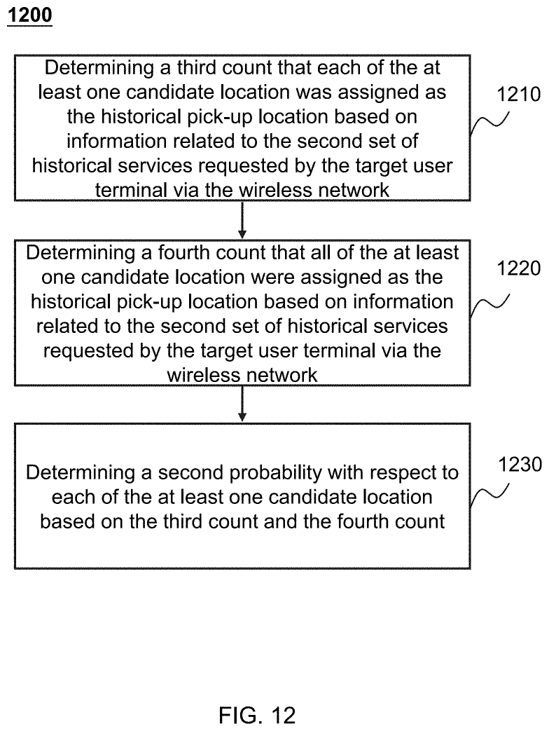

In some embodiments, the processor 220 (or the likelihood score determination module 440) may determine the second probability based on a third count that each of the at least one candidate location was assigned as the historical pick-up location and a fourth count that all of the at least one candidate location were assigned as historical pick-up locations. The processor 220 may determine the third count and/or the fourth count based on information related to the second set of historical services requested by the target user terminal in the area. For example, the second probability with respect to each of the at least one candidate location may be a ratio of the third count to the fourth count. In some embodiments, the third count may be a total number of times that each of the at least one candidate location was used as a historical pick-up location in the second set of historical services requested by the target user terminal via the wireless network in the area. The fourth count may be a total number of times that all of the at least one candidate location were used as the historical pick-up locations in the second set of historical services requested by the target user terminal via the wireless network in the area. The determination of the second probability may be found in FIG. 12 and the description thereof in the present disclosure.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step, a preprocessing step) may be added elsewhere in the exemplary process/method 600. As another example, all the steps in the exemplary process/method 600 may be implemented in a computer-readable medium including a set of instructions. The instructions may be transmitted in a form of electronic current or electrical signals.

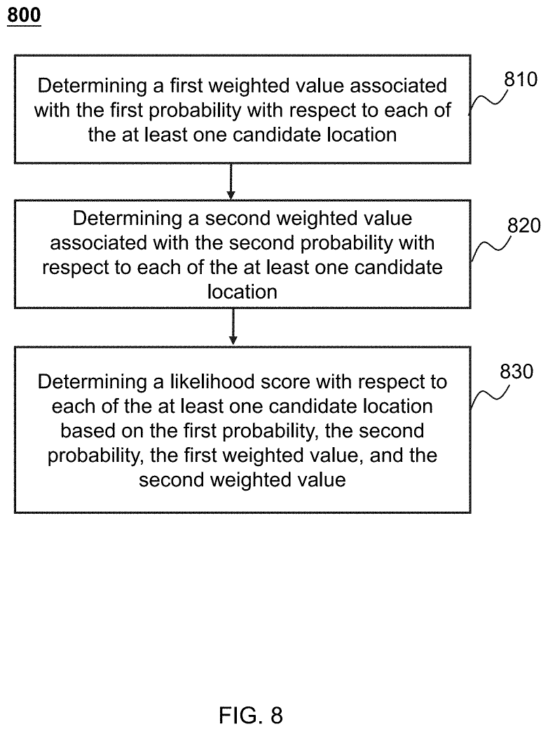

FIG. 8 is a flowchart of an exemplary process and/or method 800 for determining a likelihood score with respect to each of at least one candidate location according to some embodiments of the present disclose. In some embodiments, one or more steps in the process 800 may be implemented in the system 100 illustrated in FIG. 1. For example, one or more steps in the process 800 may be stored in the storage device 130 and/or the storage (e.g., the ROM 230, the RAM 240, etc.) as a form of instructions, and invoked and/or executed by the server 110 (e.g., the processing engine 112 in the server 110, or the processor 220 of the processing engine 112 in the server 110).

In 810, the processor 220 (or the likelihood determination module 440) may determine a first weighted value associated with the first probability with respect to each of the at least one candidate location.

In some embodiments, the first weighted value may represent a relative importance degree of the first probability in the determination process of the likelihood score with respect to each of the at least one candidate location. The higher the relative importance degree of the first probability, the higher the first weighted value. In some embodiments, the first weighted value may be a positive numerical value between 0 and 1. For example, the first weighted value may be a positive numerical value between 0 and 0.5. In some embodiments, the first weighted value may be a preset value stored in a storage (e.g., the storage device 130, the ROM 230, the RAM 240, etc.) of the system 100, or may be determined according to different applications scenarios.

In 820, the processor 220 (or the likelihood determination module 440) may determine a second weighted value associated with the second probability with respect to each of the at least one candidate location.

In some embodiments, the second weighted value may represent a relative importance degree of the second probability in the determination process of the likelihood score with respect to each of the at least one candidate location. In some embodiments, the processor 220 (or the likelihood score determination module 440) may determine a higher importance of the information related to the second set of historical services than the information related to the first set of historical services, which means that the second weighted value associated with the second probability may be greater than the first weighted value associated with the first probability. In some embodiments, the processor 220 (or the likelihood score determination module 440) may determine a higher importance of the information related to the first set of historical services than the information related to the second set of historical services, which means that the first weighted value associated with the first probability may be greater than the second weighted value associated with the second probability.

In some embodiments, the second weighted value may be a positive numerical value between 0 and 1. For example, the first weighted value may be a positive numerical value between 0.5 and 1. In some embodiments, the sum of the second weighted value and the first weighted value may be 1. For example, if the first weighted value is 0.3, the second first weighted value may be determined as 0.7. In some embodiments, the second weighted value may be a preset value stored in a storage (e.g., the storage device 130, the ROM 230, the RAM 240, etc.) of the system 100, or may be determined according to different applications scenarios.

In 830, the processor 220 (or the likelihood determination module 440) may determine a likelihood score with respect to each of at least one candidate location based on the first probability, the second probability, the first weighted value, and the second weighted value.

In some embodiments, the processor 220 (or the likelihood determination module 440) may multiply the first weighted value by the first probability with respect to each of the at least one candidate location to obtain a first weighted probability. For example, a candidate location A in the area has a first probability of 0.2, a candidate location B in the area has a first probability of 0.8, and the first weighted value is 0.3. The processor 220 (or the likelihood determination module 440) may determine the first weighted probability of candidate location A as 0.06 and the first weighted probability of candidate location B as 0.24. The 0.06 may form part of the likelihood score of the candidate location A and the 0.24 may form part of the likelihood score of the candidate location B.

In some embodiments, the processor 220 (or the likelihood determination module 440) may multiply the second weighted value by the second probability with respect to each of the at least one candidate location to obtain a second weighted probability. For example, a candidate location A in the area has a second probability of 0.9, a candidate location B in the area has a second probability of 0.1, and the second weighted value is 0.7. The processor 220 (or the likelihood determination module 440) may determine the second weighted probability of candidate location A as 0.63 and the first weighted probability of candidate location B as 0.07. The 0.63 may form part of the likelihood score of the candidate location A and the 0.07 may form part of the likelihood score of the candidate location B.

In some embodiments, the likelihood score with respect to each of the candidate location may indicate a probability that the target user terminal may use the each of the candidate location as the pick-up location in the area. The processor 220 (or the likelihood determination module 440) may determine the likelihood score with respect to each of the at least one candidate location by adding the first weighted probability and the second weighted probability. For example, a candidate location A has the first weighted probability of 0.06 and the second weighted probability of 0.63, a candidate location B has the first weighted probability of 0.24 and the second weighted probability of 0.07. The processor 220 (or the likelihood determination module 440) may determine 0.69 (adding 0.06 and 0.63) as the likelihood score with respect to the candidate location A. The processor 220 (or the likelihood determination module 440) may determine 0.31 (adding 0.24 and 0.07 as the likelihood score with respect to the candidate location B. When the target user terminal sending the service request via the wireless network in the area, the probability that the target user terminal may use the candidate location A as the pick-up location is 69%, and the probability that the target user terminal may use the candidate location B as the pick-up location is 31%.

Merely by way of example, a certain location C is a historical pick-up location that the target user terminal often used when requesting historical services via the wireless network in the area, but is rarely used by other user terminals when requesting historical services via the wireless network in the area. The certain location C is not included in the at least one candidate location, the processor 220 may add the certain location C into the at least one candidate location to determine the likelihood score with respect to the certain location C. For example, the processor 220 (or the likelihood score determination module 440) may determine the first probability of the certain location as 0 based on the information related to the first set of historical services, and the second probability of the certain location as 0.7 based on the information related to the second set of historical services. The first weighted value is 0.3 and the second weighted value is 0.7. The processor 220 (or the likelihood score determination module 440) may determine the likelihood score of the certain location C as 0.49 (0+0.49). Then the processor 220 (or the pick-up location determination module 450) may determine a pick-up location from the candidate locations including the certain location C based on the likelihood scores.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step, a preprocessing step) may be added elsewhere in the exemplary process/method 800. As another example, all the steps in the exemplary process/method 800 may be implemented in a computer-readable medium including a set of instructions. The instructions may be transmitted in a form of electronic current or electrical signals.

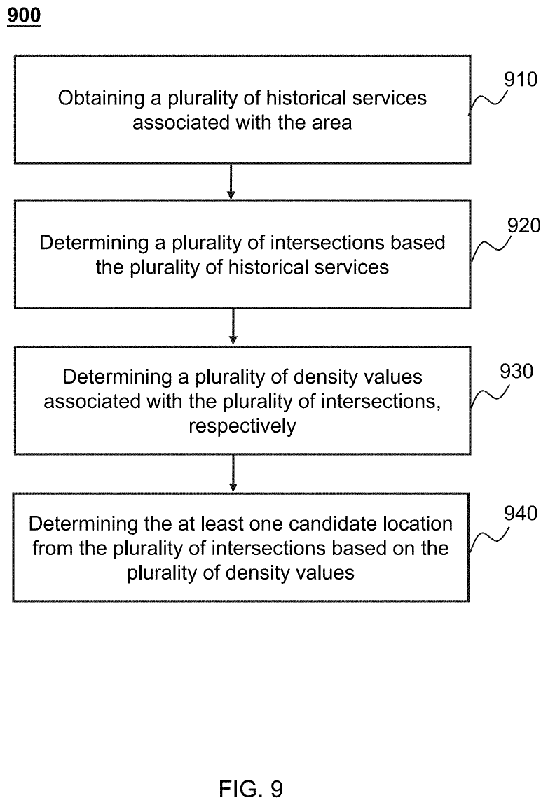

FIG. 9 is a flowchart of an exemplary process and/or method 900 for determining at least one candidate location in an area according to some embodiments of the present disclose. In some embodiments, one or more steps in the process 900 may be implemented in the system 100 illustrated in FIG. 1. For example, one or more steps in the process 900 may be stored in the storage device 130 and/or the storage (e.g., the ROM 230, the RAM 240, etc.) as a form of instructions, and invoked and/or executed by the server 110 (e.g., the processing engine 112 in the server 110, or the processor 220 of the processing engine 112 in the server 110).

In 910, the processor 220 (or the candidate location determination module 430) may obtain a plurality of historical services associated with the area.

In some embodiments, the plurality of historical services may include services (e.g., online car hailing services, taxi services, tailored car services, or the like.) requested by a plurality of user terminals via the wireless network in the area during a certain time period, for example, a week, a month, a quarter, a year, or the like. One user terminal may correspond to one or more historical services. In some embodiments, the processor 220 may obtain a predetermined number of historical servers recently requested by a plurality of user terminals via the wireless network in the area. In some embodiments, the processor 220 (or the candidate location determination module 430) may access the storage device 130 and/or the storage (e.g., the ROM 230, the RAM 240, etc.) to obtain the plurality of historical services associated with the area.

In 920, the processor 220 (or the candidate location determination module 430) may determine a plurality of intersections based on the plurality of historical services.

In some embodiments, for each historical service of the plurality of historical services, the intersection may include a location where the service provider and the service requester meet each other. For example, in a historical car hailing service, the intersection may be a location where the service provider (such as a driver) meets the service requester (such as a passenger). The driver may pick up the passenger and/or begin to charge for the service at the intersection. In some embodiments, the intersections may include a crossroad, a road junction, a bus station, a subway entrance, a gate of a building, a gate of a community, a gate of a park, or the like, or any combination thereof.

In some embodiments, the processor 220 (or the candidate location determination module 430) may determine the plurality of intersections according to the positioning information associated with the plurality of historical services. Each historical service may include an intersection. For example, for a historical car hailing service, the processor 220 (or the candidate location determination module 430) may obtain a trace of a user terminal that requested the historical car hailing service based on the positioning information of the user terminal and a trace of a driver terminal that received the historical car hailing service based on the positioning information of the driver terminal. The processor 220 may determine the intersection of the historical service based on the cross point of the two traces. Each historical service may correspond to an intersection. The determination of the plurality of intersections may be found in FIG. 10 and the description thereof in the present disclosure.

In 930, the processor 220 (or the candidate location determination module 430) may determine a plurality density values associated with the plurality of intersections, respectively.

In some embodiments, for each of the plurality of intersections, the density value of the intersection may represent a probability of using the intersection as a candidate location. The processor 220 (or the candidate location determination module 430) may determine the plurality of density values according to a density peak clustering algorithm. For example, if an intersection dataset S={xᵢ}ᵢ₌₁ⁿ, may include the plurality of intersections, wherein xᵢ is an intersection, the processor 220 (or the candidate location determination module 430) may determine a local density ρ of each intersection according to equation (1):

ρᵢ=Σ_{j∈I}_{_{S}}χ(dᵢⱼ−d_{c}) (1),

wherein I_{S}={1, 2, . . . , n} denotes an index set corresponding to the intersection dataset, ρᵢ denotes the local density, j denotes an arbitrary value in the index set I_{S} except i, dᵢⱼ denotes a certain distance (e.g., an actual distance, an Euclidean distance, or the like) between the intersection xᵢ and the intersection xⱼ, d_{c} denotes a cutoff distance which may be pre-defined by the processor 220. In some embodiments, the x may be determined according to equation (2):

$$χ ( x ) = \{ \begin{matrix}1 , & x < 0 \\ 0 , & x \geq 0\end{matrix} , \qquad ( 2 )$$

wherein ρᵢ may represent the number of intersections that the distance between the intersection and xᵢ is less than d_{c}. The intersections may be included in the dataset S.

After determining the local density of each of the plurality of the intersection, the processor 220 (or the candidate location determination module 430) may determine a distance δ between an intersection and another intersection according to equation (3):

$${δ}_{i} = {min}_{j \text{:} {ρ}_{j} > {ρ}_{i}} ( {d}_{ij} ) , \qquad ( 3 )$$

wherein δᵢ denotes the distance between the intersection xᵢ and another intersection in the dataset S. When the local density ρᵢ of the intersection is not the biggest value among the plurality of intersections, the δᵢ may represent the minimum distance between the intersection xᵢ and an intersection with a bigger local density. If the intersection xᵢ has the biggest local density, the distance δᵢ may be represented according to equation (4):

$${δ}_{i} = {min}_{j} ( {d}_{ij} ) , \qquad ( 4 )$$

wherein δᵢ may represent the maximum distance between the intersection xᵢ and another intersection in the dataset S.

Then, the processor 220 (or the candidate location determination module 430) may determine the density value γ for each of the plurality of intersections based on the local density and the distance. The density value may be a comprehensive metric for each of the plurality of intersections. The bigger the comprehensive metric, the higher the probability of the each of the plurality of intersections being a candidate location. The density value γ may be determined according to equation (5):

γᵢ=ρᵢδᵢ,i∈I_{S} (5),

wherein ρᵢ denotes to the local density and δᵢ denotes to the distance.

In 940, the processor 220 (or the candidate location determination module 430) may determine at least one candidate location from the plurality of intersections based on the plurality of density values.

In some embodiments, the at least one candidate location may include a potential location at which a service provider starts providing a service initiated by a user terminal in the area. For example, in an online car hailing service, the at least one candidate location may include a location where the service provider (such as a driver) picks up the service requester (such as a passenger), or a location where the driver begins to charge for the service being provided to the passenger. In some embodiments, the at least one candidate location may include a historical service location in the area. For example, in a historical online taxi service, the at least one candidate location may include a historical location where a driver picked up a passenger in the area and provided the historical online taxi service to the passenger. In some embodiments, the processor 220 (or the candidate location determination module 430) may compare the density value of the plurality of intersections with a threshold, respectively. The processor 220 may designate at least one intersection having the density value greater than the threshold as the at least one candidate location(s). The threshold may be a preset value stored in system, or may be determined according to different applications scenarios.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step, a preprocessing step) may be added elsewhere in the exemplary process/method 900. As another example, all the steps in the exemplary process/method 900 may be implemented in a computer-readable medium including a set of instructions. The instructions may be transmitted in a form of electronic current or electrical signals.

FIG. 10 is a flowchart of an exemplary process and/or method 1000 for determining an intersection according to some embodiments of the present disclose. In some embodiments, one or more steps in the process 1000 may be implemented in the system 100 illustrated in FIG. 1. For example, one or more steps in the process 1000 may be stored in the storage device 130 and/or the storage (e.g., the ROM 230, the RAM 240, etc.) as a form of instructions, and invoked and/or executed by the server 110 (e.g., the processing engine 112 in the server 110, or the processor 220 of the processing engine 112 in the server 110).

In 1010, the processor 220 (or the candidate location determination module 430) may obtain a user terminal trace associated with each of a plurality of historical services.

In some embodiments, the user terminal trace may include a motion track of the user terminal. For example, the user terminal trace may include a motion track of the user terminal from a location where the user terminal initiated a historical service request to a location where a service provider (e.g., a driver) began to provide the historical service. For another example, the user terminal trace may include a motion track of the user terminal from a location where the user terminal initiated a historical service request to a location where the historical service was completed. Merely by way of example, in a historical car hailing service, a user terminal may initiate the historical service request in an office of a building and get into a car that provides the historical service at a crossroad near the building. The user may walk to the crossroad from the office. The walk track may be stored as the user terminal trace associated with the historical car hailing service.

The processor 220 (or the candidate location determination module 430) may obtain the user terminal trace associated with each historical service of the plurality of historical services based on the positioning information of the user terminal. For example, the processor 220 (or the candidate location determination module 430) may obtain the locations of the user terminal at every regular time interval (e.g., 1 second, 2 seconds, 3 seconds, 4 seconds, 5 seconds, or the like) and connect all the locations at the regular time intervals to obtain the user terminal trace associated with each historical service of the plurality of historical services.

In 1020, the processor 220 (or the candidate location determination module 430) may obtain a driver terminal trace associated with the each of the plurality of historical services.

In some embodiments, the driver terminal trace may include a motion track of the driver terminal. For example, the driver terminal trace may include a motion track of the driver terminal from a location where the driver of the driver terminal accepted the historical service to a location where the driver began to provide the historical service. For another example, the driver terminal trace may include a motion track of the driver terminal from a location where the driver of the driver terminal accepted the historical service to a location where the historical service was completed. Merely by way of example, in a historical car hailing service, the driver of the driver terminal may accept the historical service when driving on a street or parking at a roadside and drive to a crossroad to pick up the requester of the historical service. The driving track may be stored as the driver terminal trace associated with the historical car hailing service.

The processor 220 (or the candidate location determination module 430) may obtain the driver terminal trace associated with each historical service of the plurality of historical services based on the positioning information of the driver terminal. For example, the processor 220 (or the candidate location determination module 430) may obtain the locations of the driver terminal at every regular time intervals (e.g., 1 second, 2 seconds, 3 seconds, 4 seconds, 5 seconds, or the like) and connect all the positioning locations at the regular time intervals to obtain the driver terminal trace associated with each historical service of the plurality of historical services.

In 1030, the processor 220 (or the candidate location determination module 430) may determine an intersection based on the user terminal trace and the driver terminal trace.

In some embodiments, for each historical service of the plurality of historical services, the user terminal trace may intersect with the driver terminal trace at an intersection. For example, in a historical car hailing service, the user terminal trace may be a walking trace from a building to a crossroad, and the driver terminal trace may be a driving route from a certain road to the crossroad. The user terminal trace may intersect the driver terminal at the crossroad. The processor 220 (or the candidate location determination module 430) may designate the crossroad as the intersection of the historical car hailing service.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step, a preprocessing step) may be added elsewhere in the exemplary process/method 1000. As another example, all the steps in the exemplary process/method 1000 may be implemented in a computer-readable medium including a set of instructions. The instructions may be transmitted in a form of electronic current or electrical signals.

FIG. 11 is a flowchart of an exemplary process and/or method 1100 for determining a first probability with respect to each of at least one candidate location according to some embodiments of the present disclose. In some embodiments, one or more steps in the process 1100 may be implemented in the system 100 illustrated in FIG. 1. For example, one or more steps in the process 1100 may be stored in the storage device 130 and/or the storage (e.g., the ROM 230, the RAM 240, etc.) as a form of instructions, and invoked and/or executed by the server 110 (e.g., the processing engine 112 in the server 110, or the processor 220 of the processing engine 112 in the server 110).

In 1110, the processor 220 (or the likelihood score determination module 440) may determine a first count that each of the at least one candidate location was assigned as the historical pick-up location based on information related to the first set of historical services requested via the wireless network in the area.

In some embodiments, the first count may include a total number of times that each of the at least one candidate location was used as a historical pick-up location in the first set of historical services requested via the wireless network in the area. For example, the processor 220 may determine the occurrence number of a candidate location A as a historical pick-up location in the first set of historical services requested via the wireless network as the first count of the candidate location A. As another example, the area includes a candidate location A and a candidate location B. The times that the historical pick-up location is the candidate location A in the first set of historical services requested via the wireless network in the area may be M₁ times and the times that the historical pick-up location is the candidate location B in the first set of historical services requested via the wireless network in the area may be M₂ times. The processor 220 (or the likelihood score determination module 440) may determine the first count of candidate location A as M₁ and the first count of candidate location B as M₂.

In 1120, the processor 220 (or the likelihood score determination module 440) may determine a second count that all of the at least one candidate location were assigned as the historical pick-up locations based on information related to the first set of historical services requested via the wireless network in the area.

In some embodiments, the second count may be a total number of times that all of the at least one candidate location were used as the historical pick-up locations in the first set of historical services requested via the wireless network in the area. In some embodiments, the processor 220 (or the likelihood score determination module 440) may determine the sum of the first counts (each first count corresponding to each of the at least one candidate location was used as a historical pick-up location in the first set of historical services requested via the wireless network in the area) as the second count. For example, the area includes the candidate location A and the candidate location B, and the first count of candidate location A in the area is M₁ and the first count of candidate location B in the area is M₂. The processor 220 (or the likelihood score determination module 440) may determine the second count as (M₁+M₂).

In 1130, the processor 220 (or the likelihood score determination module 440) may determine a first probability with respect to each of the at least one candidate location based on the first count and the second count.

In some embodiments, the first probability may correspond to a first likelihood of the each of the at least one candidate location being assigned as a historical pick-up location in response to the first set of historical services requested via the wireless network in the area. Each of the at least one candidate location may be associated with a first probability. In some embodiments, the processor 220 (or the likelihood score determination module 440) may determine the first probability with respect to each of the at least one candidate as a ratio of the first count to the second count. For example, the processor 220 (or the likelihood score determination module 440) may divide the first count by the second count to obtain the first probability with respect to each of the at least one candidate. For example, the first count of candidate location A in the area is M₁ and first count of candidate location B in the area is M₂. The second count is (M₁+M₂). The processor 220 (or the likelihood score determination module 440) may determine the first probability of the candidate location A included in the area as M₁/(M₁+M₂) and the first probability of the candidate location B included in the area as M₂/(M₁+M₂).

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step, a preprocessing step) may be added elsewhere in the exemplary process/method 1100. As another example, all the steps in the exemplary process/method 1100 may be implemented in a computer-readable medium including a set of instructions. The instructions may be transmitted in a form of electronic current or electrical signals.

FIG. 12 is a flowchart of an exemplary process and/or method 1200 for determining a second probability with respect to each of at least one candidate location according to some embodiments of the present disclose. In some embodiments, one or more steps in the process 1200 may be implemented in the system 100 illustrated in FIG. 1. For example, one or more steps in the process 1200 may be stored in the storage device 130 and/or the storage (e.g., the ROM 230, the RAM 240, etc.) as a form of instructions, and invoked and/or executed by the server 110 (e.g., the processing engine 112 in the server 110, or the processor 220 of the processing engine 112 in the server 110).

In 1210, the processor 220 (or the likelihood score determination module 440) may determine a third count that each of the at least one candidate location was assigned as the historical pick-up location based on information related to the second set of historical services requested by the target user terminal via the wireless network.

In some embodiments, the third count may include a total number of times that each of the at least one candidate location was used as a historical pick-up location in the second set of historical services requested by the target user terminal via the wireless network in the area. For example, the processor 220 may determine the occurrence number of determined candidate location as the third count of the candidate location. As another example, the area includes a candidate location A and a candidate location B. The times that the historical pick-up location is used as the candidate location A in the second set of historical services requested by the target user terminal via the wireless network in the area may be M₃ and the times that the historical pick-up location is used as the candidate location B is M₄. The processor 220 (or the likelihood score determination module 440) may determine the first count of candidate location A as M₃ and the first count of candidate location B as M₄.

In 1220, the processor 220 (or the likelihood score determination module 440) may determine a fourth count that all of the at least one candidate location were assigned as the historical pick-up locations based on information related to the second set of historical services requested by the target user terminal via the wireless network.

In some embodiments, the fourth count may be a total number of times that all of the at least one candidate location were used as the historical pick-up locations in the second set of historical services requested by the target user terminal via the wireless network in the area. In some embodiments, the processor 220 (or the likelihood score determination module 440) may determine the sum of the third count (each third count corresponding to each of the at least one candidate location was used as a historical pick-up location in the second set of historical services requested by the target user terminal via the wireless network in the area) as the fourth count. For example, the area include a candidate location A and a candidate location B, and the third count of candidate location A in the area is M₃ and the third count of candidate location B in the area is M₄ The processor 220 (or the likelihood score determination module 440) may determine the fourth count as (M₃+M₄).

In 1230, the processor 220 (or the likelihood score determination module 440) may determine the second probability with respect to each of the at least one candidate location based on the third count and the fourth count. In some embodiments, the second probability may correspond to a second likelihood of the each of the at least one candidate location being assigned as a historical pick-up location in response to the second set of historical services requested by the target user terminal via the wireless network in the area. Each of the at least one candidate location may be associated with a second probability. In some embodiments, the processor 220 (or the likelihood score determination module 440) may determine the second probability with respect to each of the at least one candidate as a ratio of the third count to the fourth count. For example, the processor 220 (or the likelihood score determination module 440) may divide the third count by the fourth count to obtain the second probability with respect to each of the at least one candidate. For example, the third count of candidate location A in the area is M₃ and third count of candidate location B in the area is M₄. The fourth count is (M₃+M₄). The processor 220 (or the likelihood score determination module 440) may determine the second probability of the candidate location A as M₃/(M₃+M₄) and the first probability of the candidate location B as M₄/(M₃+M₄).

In some embodiments, the target user terminal may use a certain location P as historical pick-up location when requesting historical services via the wireless network in the area. The certain location P is not included in the at least one candidate and is rarely used by other user terminals when requesting historical services via the wireless network in the area. In some embodiments, the processor 220 may add the certain location P into the at least one candidate location to determine the first probability and the second probability with respect to the certain location P. For example, the processor 220 (or the likelihood score determination module 440) may determine the first probability of the certain location as 0 based on the information related to the first set of historical services and the second probability based on the third count that the certain location was assigned as the historical pick-up location and the fourth count that all of the at least one candidate location were assigned as the historical pick-up location. For example, the third count of candidate location A included in the area is M₃, the third count of candidate location B included in the area is M₄ and the third count of the certain location P is M₅, the fourth count that all of the at least one candidate location were assigned as the historical pick-up location may be determined as (M₃+M₄+M₅). The processor 220 (or the likelihood score determination module 440) may determine the second probability of the candidate location A as M₃/(M₃+M₄+M₅), the second probability of the candidate location B as M₄/(M₃+M₄+M₅) and the second probability of the certain location P as M₅/(M₃+M₄+M₅). The processor 220 (or the likelihood score determination module 440) may further determine the likelihood score with respect to each of the at least one candidate location based on the second probability.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step, a preprocessing step) may be added elsewhere in the exemplary process/method 1200. As another example, all the steps in the exemplary process/method 1200 may be implemented in a computer-readable medium including a set of instructions. The instructions may be transmitted in a form of electronic current or electrical signals.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by the present disclosure, and are within the spirit and scope of the exemplary embodiments of the present disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment,” “one embodiment,” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “block,” “module,” “engine,” “unit,” “component,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 1703, Perl, COBOL 1702, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a software as a service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution—e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A system for recommending a pick-up location, comprising:
at least one computer-readable storage medium including a set of instructions for recommending a pick-up location in response to a service request; and
at least one processor in communication with the computer-readable storage medium, wherein when executing the set of instructions, the at least one processor is directed to:
receive a service request from a target user terminal;
determine an area associated with a position of the target user terminal;
determine at least one candidate location in the area;
obtain information related to a wireless network via which the target user terminal sends the service request;
determine a likelihood score with respect to each of the at least one candidate location based on the information associated with the target user terminal and the wireless network;
determine a pick-up location from the at least one candidate location based on the likelihood scores associated with the at least one candidate location; and
send the pick-up location to the target user terminal in response to the service request.

2. The system of claim 1, wherein to determine the likelihood score with respect to each of the at least one candidate location based on the information associated with the target user terminal and the wireless network, the at least one processor is further directed to:
obtain information related to a first set of historical services requested via the wireless network from the area; and
determine a first probability with respect to each of the at least one candidate location based on the information related to the first set of historical services, wherein
the first probability corresponds to a first likelihood of the each of the at least one candidate location being assigned as a historical pick-up location in response to the first set of historical services requested via the wireless network in the area.

3. The system of claim 2, wherein the at least one processor is further directed to:
obtain information related to a second set of historical services requested by the target user terminal via the wireless network; and
determine a second probability with respect to each of the at least one candidate location based on the information related to the second set of historical services, wherein
the second probability corresponds to a second likelihood of the each of the at least one candidate location being assigned as a historical pick-up location in response to the second set of historical services requested by the target user terminal via the wireless network.

4. The system of claim 3, wherein the at least one processor is further directed to:
determine a first weighted value associated with the first probability with respect to each of the at least one candidate location;
determine a second weighted value associated with the second probability with respect to each of the at least one candidate location; and
determine the likelihood score with respect to each of the at least one candidate location based on the first probability, the second probability, the first weighted value, and the second weighted value.

5. The system of claim 1, wherein to determine the at least one candidate location in the area, the at least one processor is further directed to:
obtain a plurality of historical services associated with the area;
determine a plurality of intersections based the plurality of historical services;
determine a plurality of density values associated with the plurality of intersections, respectively; and
determine the at least one candidate location from the plurality of intersections based on the plurality of density values.

6. The system of claim 5, wherein to determine the plurality of intersections based the plurality of historical services, the at least one processor is further directed to:
for each of the plurality of historical services,
obtain a user terminal trace associated with the each of the plurality of historical services;
obtain a driver terminal trace associated with the each of the plurality of historical services; and
determine an intersection based on the user terminal trace and the driver terminal trace.

7. The system of claim 5, wherein to determine the plurality of density values associated with the plurality of intersections, the at least one processor is further directed to:
determine the plurality of density values according to a density peaks clustering algorithm.

8. The system of claim 2, wherein to determine the first probability with respect to each of the at least one candidate location based on the information related to the first set of historical services, the at least one processor is further directed to:
determine a first count that each of the at least one candidate location was assigned as the historical pick-up location based on information related to the first set of historical services requested via the wireless network in the area;
determine a second count that all of the at least one candidate location were assigned as the historical pick-up location based on information related to the first set of historical services requested via the wireless network in the area; and
determine the first probability with respect to each of the at least one candidate location based on the first count and the second count.

9. The system of claim 3, wherein to determine the second probability with respect to each of the at least one candidate location based on the information related to the second set of historical services, the at least one processor is further directed to:
determine a third count that each of the at least one candidate location was assigned as the historical pick-up location based on information related to the second set of historical services requested by the target user terminal via the wireless network;
determine a fourth count that all of the at least one candidate location were assigned as the historical pick-up location based on information related to the second set of historical services requested by the target user terminal via the wireless network; and
determine the second probability with respect to each of the at least one candidate location based on the third count and the fourth count.

10. A method for recommending a pick-up location implemented on a computing device having at least one processor, at least one computer-readable storage medium, and a communication platform connected to a network, comprising:
receiving a service request from a target user terminal;
determining an area associated with a position of the target user terminal;
determining at least one candidate location in the area;
obtaining information related to a wireless network via which the target user terminal sends the service request;
determining a likelihood score with respect to each of the at least one candidate location based on the information associated with the target user terminal and the wireless network;
determining a pick-up location from the at least one candidate location based on the likelihood scores associated with the at least one candidate location; and
sending the pick-up location to the target user terminal in response to the service request.

11. The method of claim 10, wherein determining the likelihood score with respect to each of the at least one candidate location based on the information associated with the target user terminal and the wireless network includes:
obtaining information related to a first set of historical services requested via the wireless network from the area; and
determining a first probability with respect to each of the at least one candidate location based on the information related to the first set of historical services, wherein
the first probability corresponds to a first likelihood of the each of the at least one candidate location being assigned as a historical pick-up location in response to the first set of historical services requested via the wireless network in the area.

12. The method of claim 11, further comprising:
obtaining information related to a second set of historical services requested by the target user terminal via the wireless network; and
determining a second probability with respect to each of the at least one candidate location based on the information related to the second set of historical services, wherein
the second probability corresponds to a second likelihood of the each of the at least one candidate location being assigned as a historical pick-up location in response to the second set of historical services requested by the target user terminal via the wireless network.

13. The method of claim 12 further comprising:
determining a first weighted value associated with the first probability with respect to each of the at least one candidate location;
determining a second weighted value associated with the second probability with respect to each of the at least one candidate location; and
determining the likelihood score with respect to each of the at least one candidate location based on the first probability, the second probability, the first weighted value, and the second weighted value.

14. The method of claim 10, wherein determining the at least one candidate location in the area includes:
obtaining a plurality of historical services associated with the area;
determining a plurality of intersections based the plurality of historical services;
determining a plurality of density values associated with the plurality of intersections, respectively; and
determining the at least one candidate location from the plurality of intersections based on the plurality of density values.

15. The method of claim 14, wherein determining the plurality of intersections based the plurality of historical services includes:
for each of the plurality of historical services,
obtaining a user terminal trace associated with the each of the plurality of historical services;
obtaining a driver terminal trace associated with the each of the plurality of historical services; and
determining an intersection based on the user terminal trace and the driver terminal trace.

16. The method of claim 14, wherein determining the plurality of density values associated with the plurality of intersections includes:
determining the plurality of density values according to a density peaks clustering algorithm.

17. The method of claim 11, wherein determining the first probability with respect to each of the at least one candidate location based on the information related to the first set of historical services includes:
determining a first count that each of the at least one candidate location was assigned as the historical pick-up location based on information related to the first set of historical services requested via the wireless network in the area;
determining a second count that all of the at least one candidate location were assigned as the historical pick-up location based on information related to the first set of historical services requested via the wireless network in the area; and
determining the first probability with respect to each of the at least one candidate location based on the first count and the second count.

18. The method of claim 12, wherein determine the second probability with respect to each of the at least one candidate location based on the information related to the second set of historical services includes:
determining a third count that each of the at least one candidate location was assigned as the historical pick-up location based on information related to the second set of historical services requested by the target user terminal via the wireless network;
determining a fourth count that all of the at least one candidate location were assigned as the historical pick-up location based on information related to the second set of historical services requested by the target user terminal via the wireless network; and
determining the second probability with respect to each of the at least one candidate location based on the third count and the fourth count.

19. A non-transitory computer readable medium, comprising at least one set of instructions for recommending a pick-up location, wherein when executed by at least one processor of a computer device, the at least one set of instructions directs the at least one processor to:
receive a service request from a target user terminal;
determine an area associated with a position of the target user terminal;
determine at least one candidate location in the area;
obtain information related to a wireless network via which the target user terminal sends the service request;
determine a likelihood score with respect to each of the at least one candidate location based on the information associated with the target user terminal and the wireless network;
determine a pick-up location from the at least one candidate location based on the likelihood scores associated with the at least one candidate location; and
send the pick-up location to the target user terminal in response to the service request.

20. The non-transitory computer readable medium of claim 19, wherein to determine the at least one candidate location in the area, the at least one set of instructions further directs the at least one processor to:
obtain a plurality of historical services associated with the area;
determine a plurality of intersections based the plurality of historical services;
determine a plurality of density values associated with the plurality of intersections, respectively; and
determine the at least one candidate location from the plurality of intersections based on the plurality of density values.
